(19) United States
(12) Patent Application Publication
(10) Pub. No.: US 2004/0093517 A1
(43) Pub. Date: May 13, 2004

(54) Protection of shared sealed data in a trusted computing environment

(76) Inventor: Joseph F. Cihula, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/293,738

(22) Filed: Nov. 13, 2002

(51) Int. Cl. H04L 9/00

(52) U.S. Cl. 713/201

(57) ABSTRACT

A system and method for providing shared access to sealed data in a trusted computing environment are provided. A proxy requests sealing of data on behalf of the sealing entity. The proxy arbitrates requests from non-sealing entities for access to the sealed data.

### BACKGROUND

1. Technical Field

The present invention relates generally to information processing systems and, more specifically, to maintaining security of data in a computing environment.

2. Background Art

In computing environments, security has become an issue of increasing concern. Computing devices execute firmware and/or software code to perform various operations. The code may be in the form of user applications, BIOS (basic input/output system) routines, operating system routines, etc. The code is often vulnerable to corruption by viruses and other detrimental interference by unauthorized parties. Such corruption, which is typically deliberate, may simply interfere with the normal operation of the system, may destroy files and other important data, and may even be used to surreptitiously gain access to classified information. Various security measures have been developed to protect computer systems from such corruption.

One approach to making computing systems more secure is the implementation of a trusted computing environment. In some trusted computing environments, integrity metrics are collected and reported in order to determine the state of the hardware and software environment on a platform. Also, data may be “sealed” to a particular hardware and software environment on the platform such that the data is protected in that it is only available to the exact environment (including the software entity performing the sealing operation) that sealed it. In such a trusted computing environment, multiple software entities cannot share a piece of sealed data. Such an approach proves inflexible in the case where the user of a software entity may wish for another software entity to also have access to the sealed data created by the first software entity.

Embodiments of the method and apparatus disclosed herein address this and other concerns related to protection and sharing of data in a trusted computing environment.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and apparatus for protecting data in a trusted environment.

FIG. 1 is a flowchart illustrating an embodiment of a method for sealing data to be shared.

FIG. 2 is a data flow diagram depicting the flow of data to and from at least one embodiment of a proxy that facilitates sealing of shared data.

FIG. 3 is a flowchart illustrating an embodiment of a method for providing access to shared sealed data.

FIG. 4 is a data flow diagram depicting the flow of data to and from at least one embodiment of a proxy that arbitrates other-entity access requests to shared sealed data.

FIG. 5 is a functional block diagram of at least one embodiment of a computing system capable of sealing data to be shared and of providing access to shared sealed data.

FIG. 6 is a block diagram of at least one embodiment of a proxy capable of facilitating the sealing of data to be shared and capable of arbitrating other-entity requests for access to the sealed data.

### DETAILED DISCUSSION

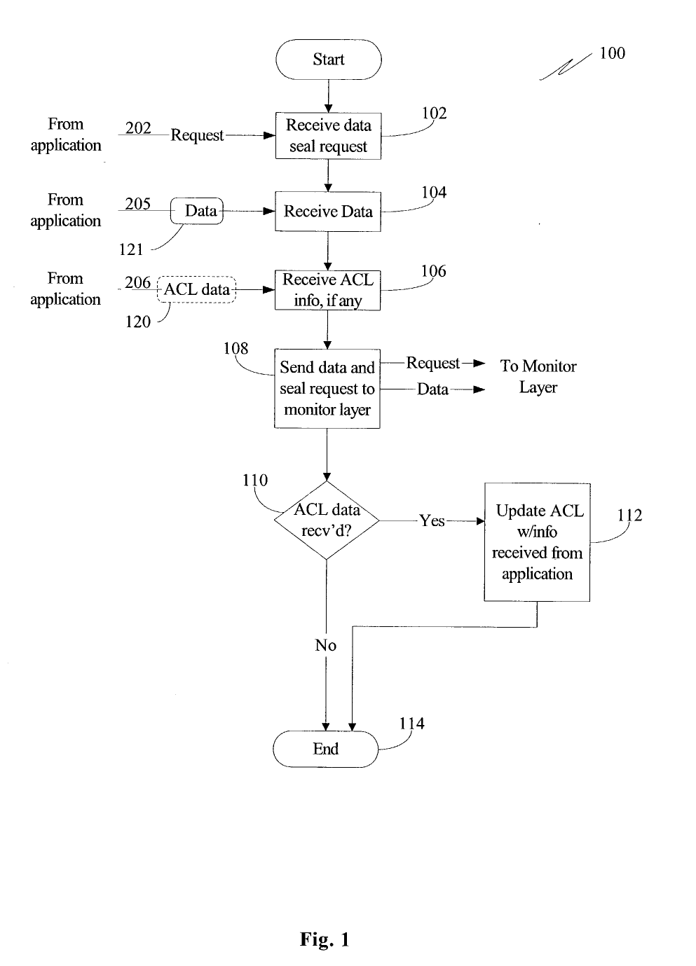

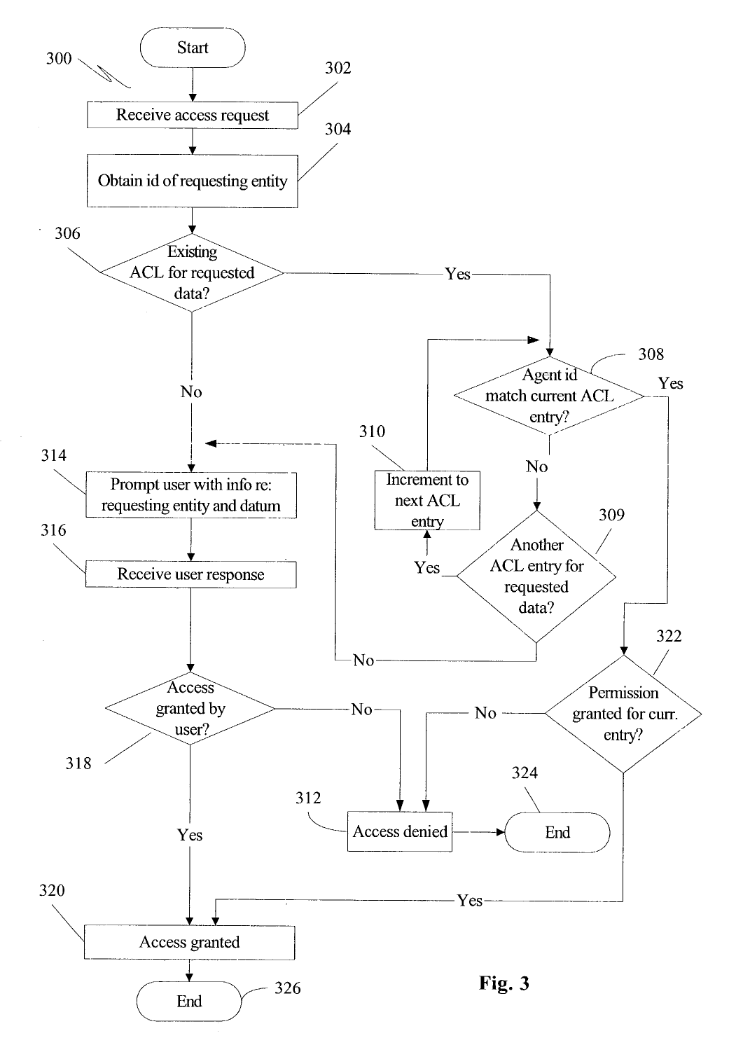

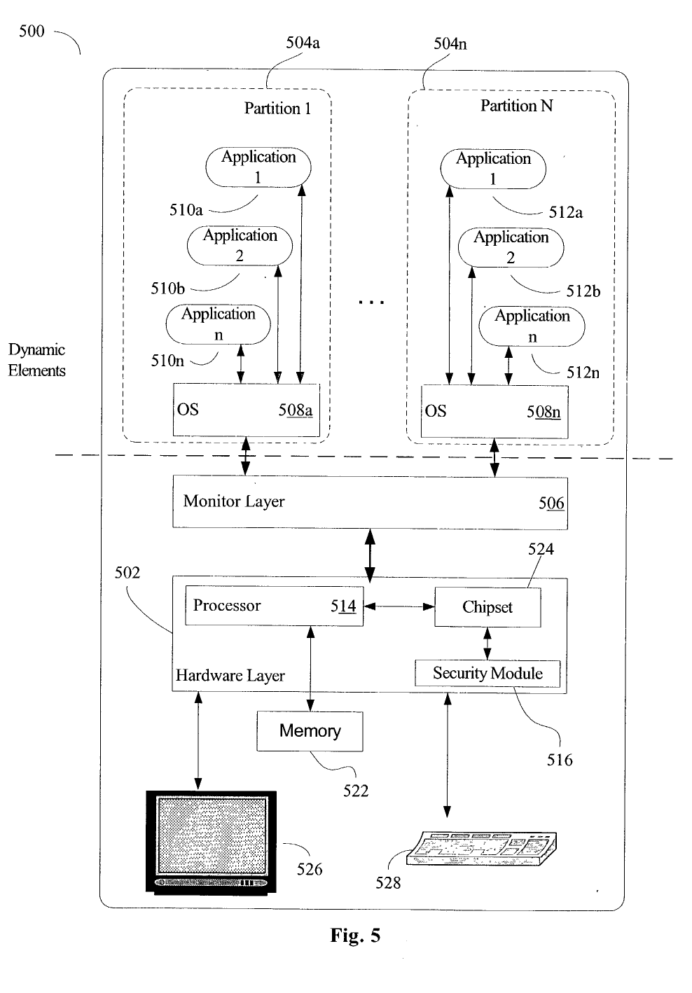

FIG. 1 is a flowchart illustrating at least one embodiment 100 of a method for sealing data to be shared in a trusted computing environment. FIG. 3 is a flowchart illustrating at least one embodiment of a method 300 for providing access to shared sealed data in a trusted computing environment. FIG. 5 is a block diagram of a computing system 500 in which the methods 100, 300 of FIGS. 1 and 3, respectively, may be performed.

FIG. 5 illustrates that a trusted computing environment is commonly known to be a combination of hardware 502, 522 and software components 506 that together provide enhanced security protection in a computing environment 500. As used herein, a trusted computing environment is a combination of hardware 502, 522 and software 506 that provides for one or more computing environments 504a-504n running on the same physical hardware 502, 522. Each of the multiple computing environments 504a, 504n within a trusted computing environment is referred to herein as a partition (Partition 1, Partition N) and is able to communicate with other partitions. One or more software entities (a collection of one or more modules or programs) 510a-510n, 512a-512n may execute in a partition 504a, 504n, respectively. Because embodiments of the methods 100, 300 discussed below may be practiced to provide for sharing of sealed data between applications 510a-510n or 512a-512n that execute in the same partition 504a or 504n, respectively, one skilled in the art will recognize that a trusted computing environment supporting only a single partition, rather than multiple partitions 504a, 504n, could be used to practice the embodiments 100, 300.

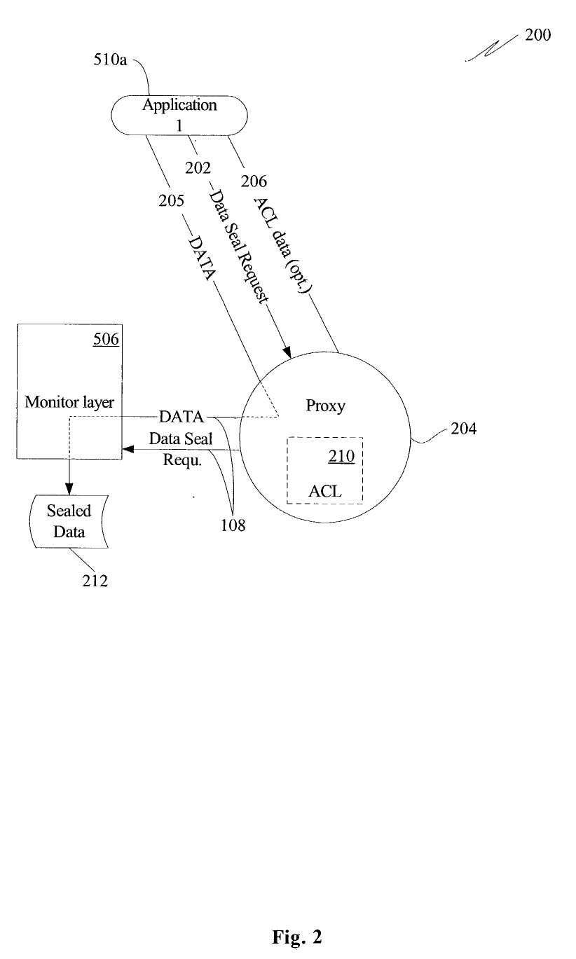

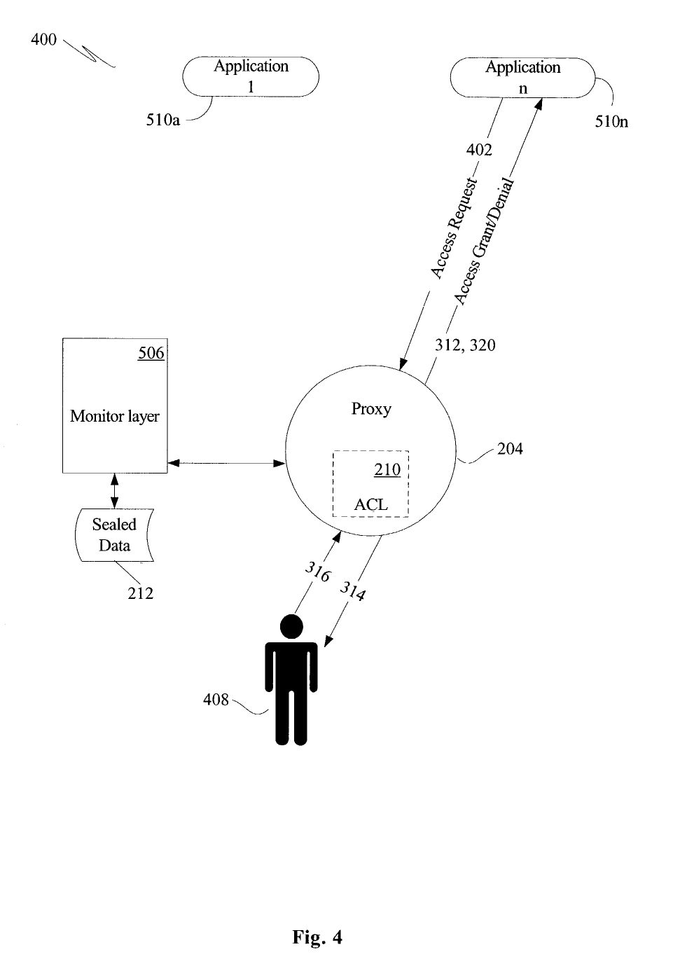

FIGS. 1 and 2 illustrate at least one embodiment of a method 100 and an illustrative flow of data 200, respectively, for sealing data that may later be shared with other (i.e., “non-sealing”) entities. FIGS. 1 and 2 illustrate that a sealing entity need not necessarily be aware of the sharing entities at the time of sealing. One skilled in the art will understand that the terms “sealing” and “non-sealing” are used in respect to a particular instance of shared data 212. That is, the same entity may be a “sealing” entity as to a particular instance of shared data 212 but a “non-sealing” entity as to any other instances of shared data 212 that were sealed due to a request by a different entity. FIGS. 1 and 2 are discussed immediately below in order to further discuss sealing of data that may be later shared with non-sealing entities. Thereafter, FIGS. 3 and 4 are referenced in connection with a discussion of a method 300 of determining whether to grant a non-sealing entity access to the previously-sealed data.

FIGS. 1, 2 and 5 illustrate that an application 510a initiates sealing of data 121 by sending 202 a data seal request to a proxy 204. The application 510a also sends 205 to the proxy 204 the data 121 to be sealed. The proxy 204 may be a component of operating system 508 (FIG. 5). Alternatively, the proxy 204 may be an application 510, 512, such as an “.exe” file, that runs in a partition 504a, 504n, respectively. One skilled in the art will recognize that the specific implementation details of the proxy 204 are not limited those expressed herein; any method of implementing the proxy 204 functionality as described herein is intended to be encompassed by the claims set forth below.

The proxy 204 receives 102 from the application 510a the data seal request and also receives 104 the data 121 to be sealed. The application 510a may optionally send 206, and the proxy 204 therefore may optionally receive 106, access control list (“ACL”) data 120. An access control list 210 is a list of identity-permission pairs. If the application 510a is aware of other entities that should have access to the data 121 being sealed, the application 510a may specify such entities, as well as the permissions to be granted to the entities, and forward 206 this information 120 to the proxy 204. For instance, the ACL information 120 may include an entity identifier and the permission (i.e., read, modify, write, etc.) associated with the entity. As used herein, the term “access control list” is intended to encompass any known manner of maintaining identity-permission pair information, including a file structure, a linked list data structure, an array data structure and the like.

In traditional systems, the entity to which data 121 is sealed is the only entity that can later access the sealed data. In such cases, the sealing entity is both the entity that requests that the monitor seal the data 121 and is also the entity that the sealed data 212 is sealed to. That is, the sealing entity makes the request to initiate sealing and is also the “owner” of the sealed data 212. For the embodiment 100 described herein, a proxy 204 is interposed such that the sealing entity requests 202 sealing of the data, but the data is sealed to the proxy 204 and the proxy 204 therefore owns the data. In this manner, the sealing entity 510a is logically distinct from the proxy 204 in that the former 510a requests 202 sealing while the latter 204 owns the sealed data. Of course, the proxy 204 can request sealing of its own data to itself, in which instance the proxy 204 is both the requesting 202 entity and the owner of the sealed data 212. If the sealed data is to be shared, the proxy 204 also acts to arbitrate other-entity requests to its sealed data 212.

By interposing the proxy 204 as owner of an instance of shared sealed data 212 in a partition 504, the proxy 204 becomes a central hub, within the partition 504, to arbitrate requests for access to that instance of shared sealed data 212 in the partition 504. One skilled in the art will recognize that a different proxy 204 may exist for each partition 504. One skilled in the art will also recognize that multiple proxies 204 may exist within the same partition 504.

The proxy 204 sends 108 the data 121, which was received at block 104, to a monitor layer 506. At block 108 the proxy 204 also sends to the monitor layer 506 a request that the data 121 be sealed with the proxy 204 as the specified owner of the sealed data 212.

For at least one embodiment it is contemplated that the monitor layer 506 (also referred to herein as a “security module”) is a software module that works in conjunction with the hardware layer 502 to provide hardware-supported security of sealed data. For at least one embodiment, the monitor layer 506 is part of an operating system, such as the operating system instances 508a, 508n illustrated in FIG. 5. The monitor layer 506 may employ any known manner of sealing the data 121 to a particular entity. For at least one embodiment, for example, the sealed data 212 is associated with hashes of the environment in which the proxy 204 is running. The hashes include an agent hash, which is a hash of the proxy's 204 code. One skilled in the art will recognize that a “hash” value h is a fixed-size result of the transformation, performed by a hash function H, of an input value x. In cryptography, the input to a hash function can be any length, the output (i.e., h) is a fixed length, H(x) is one way, H(x) is collision-free, and H(x) is relatively easy to compute for any given value of x.

FIGS. 1, 2 and 5 illustrate that, if ACL data 120 was received at block 106, the proxy 204 updates 112 an Access Control List 210 to reflect the ACL data 120. After the ACL data check 110 is performed, the ACL is updated 112 if necessary, and processing ends at block 114.

In sum, as a result of the request and data 121 sent by the proxy 204 to the monitor layer 506 at block 108, the data is sealed to create a sealed data 212 of which the proxy 204, rather than the requesting entity 510a, is the owner.

FIGS. 3, 4 and 5 illustrate at least one embodiment of a method 300 and an illustrative flow of data 400, respectively, for determining whether access to sealed data 212 should be granted to another (i.e., “non-sealing”) application 510n within a particular partition 504. Accordingly, the method of FIG. 3 provides for sharing of sealed data between software entities 510a-510n running in the same partition 504. Traditionally, as is explained above, sealed data is accessible only to the sealing entity. In contrast, the method 300 illustrated in FIG. 3, allows for a software entity 510a (sometimes referred to herein as an “application”) to provide for sharing its sealed data with other applications 510b, 510n in the same partition 504. Such data is referred to herein as “shared sealed data.”

The proxy 204, as the owner of sealed data 212, arbitrates any such requests from all non-sealing entities within the partition 504. In a system where a plurality of entities 510a-510n and 512a-512n may each create one or more instances of shared sealed data 212, centralizing the arbitration logic for all sealed data for a particular partition 504a, 504n, respectively, within a partition-specific proxy 204 efficiently isolates the arbitration logic for the partition 504 in a single entity.

The proxy 204 receives 302 an access request from a non-sealing entity, which is illustrated in FIG. 4, for purposes of example, as Application n 510n. For purposes of the example illustrated in FIG. 4, it is assumed that sealing of the shared sealed data was initiated by Application 1510a, as illustrated in FIG. 2. Accordingly, throughout the present discussion, Application 1510a will be referred to as the “sealing” entity and Application n 510n will be referred to as the “non-sealing” entity. As is stated above, in connection with the embodiments described herein, a “sealing” entity requests that data be sealed, but the sealed data is not sealed to the sealing entity. Instead, the data is sealed to the proxy.

The non-sealing entity 510n initiates the process 300 by sending 402 an access request to the proxy 204 to request access to the shared sealed data 212. As stated above, the request is received by the proxy 204 at block 302. At block 304, the proxy 204 determines the entity identifier for the non-sealing entity 510n that has requested access. At block 306 the proxy 204 determines whether an ACL 210 exists for the requested data 212. As stated above in connection with block 106 of FIG. 1, the ACL data 120 is optional. If the sealing entity 510a has not provided ACL data 120 during the sealing process 100, then an ACL 210 may not exist for the shared sealed data 212. On the other hand, a default ACL 210 may be created for each proxy 204, regardless of whether ACL data 120 is provided 206 by the sealing entity 510a. The optional nature of the ACL data 120 and the ACL 210 are illustrated by dotted lines in FIGS. 1, 2 and 4.

If the proxy 204 determines 306 that an ACL 210 exists for the shared sealed data 212 referenced in the access request sent 202 by the non-sealing entity 510n, then processing continues at block 308. If not, processing continues at block 314.

At blocks 308, 309, and 310 the proxy 204 determines whether an entry for the non-sealing entity 510n appears in the ACL 210. If so, block 322 is executed to 20 determine whether the non-sealing entity has been granted permission to access the shared sealed data 212.

If an ACL entry for the non-sealing entity 510n does not exist, then processing continues at block 314.

The proxy prompts 314 the user 408 to determine whether access permission should be granted to the non-sealing entity 510n. Such prompting 314 is performed either when no ACL exists for the requested data or when an ACL exists, but no entry exists in the ACL 210 corresponding to the non-sealing entity 510n that is requesting access. In the former case, block 314 is executed as a result of the check 306 for an ACL 210 evaluating to a “false” value. In the latter case, block 314 is executed, as is described above, as a result of the check for ACL entries 310 evaluating to “false,” which indicates that no matching entry for the non-sealing entity 510n was found in the ACL 210.

At block 314 the user 408 is prompted, via an information delivery system, with information concerning the access request. For instance, the user 408 might be presented with information to the effect that the non-sealing entity has requested access to data that was sealed by a different entity (i.e., the sealing entity). The user 408 is prompted 314 for an indication of whether or not the user 408 desires that such access be permitted. Any information delivery system may be used to deliver 314 such prompt, including audio speakers (not shown) or the like. For at least one embodiment, however, a video output display is generated and is displayed 314 to the user 408 on a computer display monitor 526. For such embodiment, security may be maintained through the use of trusted input/output. Trusted output is a manner of generating monitor 526 output displays in a secure environment that allows the user to determine that the output was generated by a secure application and that the output display was not modified or observed by an unauthorized application. Similarly, trusted input is a manner of receiving user input, such as from a keyboard 528, such that the user's 408 input to the prompt will not be observed by unauthorized applications.

The user's 408 response to the prompt is received at block 316. If the user 408 has indicated that the requested permission should be denied, then processing continues at block 312. At block 312, access is denied and the denial is communicated to the non-sealing entity. Block 312 is executed either as a result of the user 408 denying access or when the ACL 210 has a matching entry for the non-sealing entity, and the ACL entry indicates that the non-sealing entity does not have permission to access the shared sealed data 212 as requested. In the former case, block 312 is executed as a result of the user grant check 318 evaluating to a “false” value. In the latter case, block 312 is executed as a result of the current entry access check 322 evaluating to a “false” value, as is discussed above. After the access denial 312 is communicated to the non-sealing entity 510n, processing ends at block 324.

If the user grant access check 318 evaluates to a “true” value, then at block 320 access is granted and the access grant is communicated to the non-sealing entity. FIG. 3 illustrates that the granting 320 of access is also performed as a result of the current entry access check 322 evaluating to a “true” value. In other words, access will be granted if an ACL 210 entry for the non-sealing entity 510n indicates that access permission exists and will also be granted, if no matching ACL 210 entry exists, if the user indicates 316 that access should be granted. In either case, processing ends at block 326 after the access grant 320.

In sum, selected embodiments of methods for creating and protecting shared sealed data in a trusted computing environment have been described. An embodiment of sealing data 121 includes the operation of a proxy 204. The proxy 204 requests that data be scaled on behalf of the sealing entity, such that the proxy 204, rather than the sealing entity, is recorded as the “owner” of the sealed data 212. For at least one embodiment, the proxy 204 is included within an operating system 508. For at least one other embodiment, the proxy 204 is an executable application that runs in a partition 504.

Continuing to summarize, the proxy 204 arbitrates requests for access to the sealed data 212 by non-sealing entities within a particular partition 504. Upon receiving an other-entity access request, the proxy 204 determines whether an ACL 210 exists for the sealed data 212. If so, the proxy 204 further determines whether an entry in the ACL 210 corresponds to the non-sealing entity 510n that has requested access to the sealed data. If the entry indicates that the non-sealing entity 510n should have access to the sealed data 212, access is granted. If the entry indicates that the non-sealing entity 510n should not have access, access is denied. If no ACL entry exists for the requesting non-sealing entity 510n, then the proxy 204 prompts a user 408 for access information, and grants or denies access according to the user's input.

In the preceding description, various aspects of sealing shared data and granting/denying access to the sealed data have been described. For purposes of explanation, specific numbers, examples, systems and configurations were set forth in order to provide a more thorough understanding. However, it is apparent to one skilled in the art that the described methods may be practiced without the specific details. In other instances, well-known features were omitted or simplified in order not to obscure the method.

Embodiments of the method may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the dynamic method described herein is not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

An example of one such type of processing system is shown in FIG. 5. Sample system 500 may be used, for example, to execute the processing for a method of sealing shared data and a method for determining access for non-sealing entities to the sealed data, such as the embodiments described herein. Sample system 500 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, personal digital assistants and other hand-held devices, engineering workstations, set-top boxes and the like) may also be used. In one embodiment, sample system 500 may be executing a version of the Windows™ operating system available from Microsoft Corporation, although other operating systems and graphical user interfaces, for example, may also be used.

Referring to FIG. 5, sample processing system 500 includes a memory system 522 and a processor 514. Memory system 522 is intended as a generalized representation of memory and may include a variety of forms of memory, such as a hard drive, CD-ROM, random access memory (RAM), dynamic random access memory (DRAM), static random access memory (SRAM) and related circuitry.

Memory system 522 may store instructions and/or data represented by data signals that may be executed by processor 514. The instructions and/or data may include code for performing any or all of the techniques discussed herein. Once skilled in the art will recognize that, while code and data are stored in the memory system 522, the actual run-time behavior of the code is dynamic. Accordingly, FIG. 5 illustrates a static memory system 522, referred to as static because it is a non-transient feature of the system 500. FIG. 5 also illustrates an illustrative dynamic run-time “snapshot” of example partitions 504a, 504n and applications 510a-51 On, 512a-512n that may execute during run-time as a result of the information stored in the memory system 522. One skilled in the art will also recognize that instances 508a, 508n of an operating system are illustrated in FIG. 5 in terms of their dynamic instantiations, but that the code for the operating system 508 may reside (not shown) in the memory system 522. Similarly, although the proxy code 204 is illustrated in FIG. 5 to reside in the memory system 522, one or more instantiations (not shown) of the proxy 204 may be associated with each partition 504 during run-time.

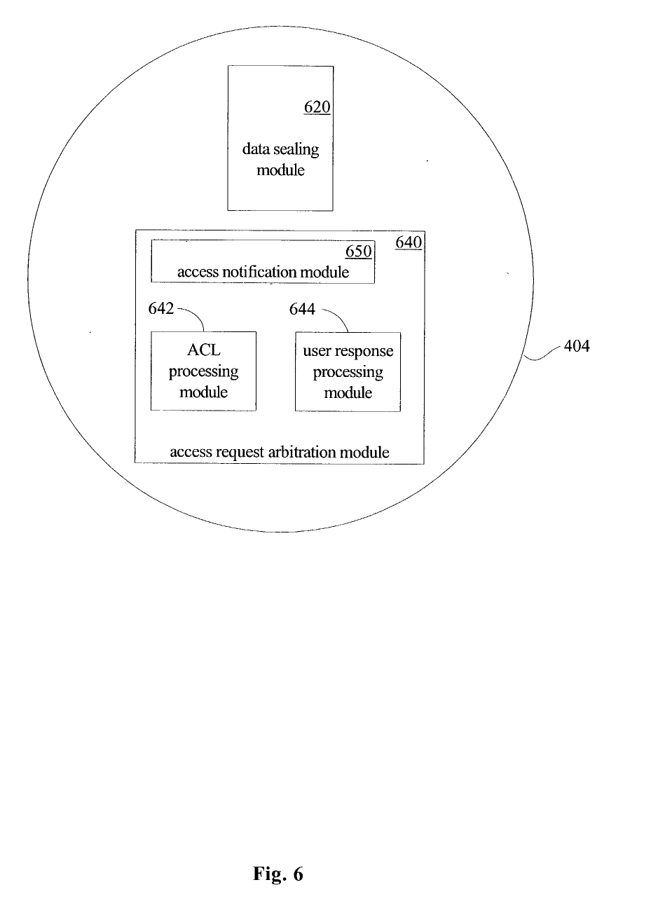

FIG. 6 illustrates that the instructions implementing the function of the proxy 204 (regardless of whether it is an independent executable application or whether it is included as code of the operating system 508) may be logically grouped into various functional modules. The proxy 204 may include a data sealing module 620 and an access request arbitration module 640.

When executed by processor 514 (FIG. 5), data sealing module 620 initiates sealing of data to the proxy 204 on behalf of a sealing entity as described above in connection with FIGS. 1 and 2. The access request arbitration module 640, when executed by the processor 514 (FIG. 5), arbitrates a request for access to the sealed data from a non-sealing entity, as described above in connection with FIGS. 3 and 4.

FIG. 6 illustrates that the access request arbitration module 640 may further include an ACL processing module 642 and a user response processing module 644. The ACL processing module 642, when executed by the processor 514 (FIG. 5), determines 306 whether an ACL 210 exists and, if so, further determines 308, 309, 310, 322 the permission associated with the non-sealing entity in the ACL 210, if an entry for the non-sealing entity exists in the ACL 210. This processing associated with the ACL processing module 642 is discussed in further detail above in connection with FIGS. 3 and 4.

When executed by the processor 514 (FIG. 5), the user response processing module 644 communicates 314, 316 with the user 408 to determine 318 whether the user wishes to grant the non-sealing entity access to the sealed data 212. Such processing is also discussed in further detail above in connection with FIGS. 3 and 4.

The access request arbitration module 640 may further logically include an access notification module 650. When executed by the processor 514 (FIG. 5), the access notification module 650 either provides 320 an access grant notification or provides 312 an access denial notification to the non-sealing entity, based on the processing of the user response processing module 644 and/or the ACL processing module 642.

While particular embodiments of the present invention have been shown and described, it will be obvious to those skilled in the art that changes and modifications can be made without departing from the present invention in its broader aspects. For instance, it should be noted that there are many mechanisms for creating an ACL 210 entry in addition to optional provision 206 of ACL data 120 by a sealing entity 510a. For example, a user could initiate the creation or updating of an ACL entry. In such embodiment, communication 314, 316 with the user 408 includes communication of the ACL entry information from the user, which is then processed to cause an update to the ACL 210. Alternatively the user may communicate desired ACL information via a graphical user interface (“GUI”) that is generated by the proxy 204 or another agent in order to update ACL information at any time, irrespective of whether a current other-entity access request is pending.

Also, for example, modifications to the user response processing 316 illustrated in FIG. 3 can be made without departing from the present invention in its broader aspects. When a user response is received at block 316, the response may be recorded as an entry in the ACL 210. If desired, processing may continue at block 306, in which case the newly-created ACL entry will cause the ACL determination at block 306 to evaluate to true. Alternatively, after the new ACL entry is created based on user input, the processing could then proceed to block 318.

The appended claims are to encompass within their scope all such changes and modifications that fall within the true scope of the present invention.

What is claimed is:

1. A method comprising:
receiving data from a sealing entity; and
requesting, responsive to a request from the sealing entity, that a security module seal the data to a proxy, the proxy being logically distinct from the sealing entity.

2. The method of claim 1, further comprising:
updating, responsive to receipt of access control information from the sealing entity, an access control list to reflect the access control information.

3. An article comprising:
a machine-readable storage medium having a plurality of machine accessible instructions;
wherein, when the instructions are executed by a processor, the instructions provide for:
receiving data from a sealing entity; and
requesting, responsive to a request from the sealing entity, that a security module seal the data to a proxy, the proxy being logically distinct from the sealing entity.

4. The article of claim 3, wherein the instructions further include instructions that provide for:
updating, responsive to receipt of access control information from the sealing entity, an access control list to reflect the access control information.

5. A method, comprising:
receiving a request for access to sealed data, the access request originating from a non-sealing entity; and
determining whether to grant the non-sealing entity access to the sealed data.

6. The method of claim 5, wherein determining whether to grant the non-sealing entity access to the sealed data further includes:
obtaining an identifier associated with the non-sealing entity;
determining that an access control list exists, the access control list being associated with the sealed data; and
determining whether the access control list contains an entry corresponding to the identifier.

7. The method of claim 6, wherein:
determining whether to grant the non-sealing entity access to the sealed data further comprises:
determining, if the access control list contains the entry corresponding to the identifier, that the access control list entry indicates that the non-sealing entity should be granted access to the sealed data.

8. The method of claim 6, wherein determining whether to grant the non-sealing entity access to the sealed data further comprises:
determining, if the access control list contains an entry corresponding to the identifier, that the access control list entry indicates that the non-sealing entity should not be granted access to the sealed data.

9. The method of claim 5, wherein determining whether to grant the non-sealing entity access to the sealed data further comprises:
prompting a user for an access selection;
receiving the access selection from the user; and
determining whether the access selection indicates that the non-sealing entity should be granted access to the sealed data.

10. An article comprising:
a machine-readable storage medium having a plurality of machine accessible instructions;
wherein, when the instructions are executed by a processor, the instructions provide for:
receiving a request for access to sealed data, the access request originating from a non-sealing entity; and
determining whether to grant the non-scaling entity access to the sealed data.

11. The article of claim 10, wherein instructions that provide for determining whether to grant the non-sealing entity access to the sealed data further include:
instructions that provide for obtaining an identifier associated with the non-sealing entity;
instructions that provide for determining that an access control list exists; and
instructions that provide for determining whether the access control list contains an entry corresponding to the identifier.

12. The article of claim 11, wherein:
instructions that provide for determining whether to grant the non-sealing entity access to the sealed data further comprise:
instructions that provide for determining, if the access control list contains an entry corresponding to the identifier, that the access control list entry indicates that the non-sealing entity should be granted access to the sealed data.

13. The article of claim 11, wherein:
instructions that provide for determining whether to grant the non-sealing entity access to the sealed data further comprise:
instructions that provide for determining, if the access control list contains an entry corresponding to the identifier, that the access control list entry indicates that the non-sealing entity should not be granted access to the sealed data.

14. The article of claim 10, wherein instructions that provide for determining whether to grant the non-sealing entity access to the sealed data further comprise:
instructions that provide for prompting a user for an access selection;
instructions that provide for receiving the access selection from the user; and
instructions that provide for determining whether the access selection indicates that the non-sealing entity should be granted access to the sealed data.

15. The article of claim 10, wherein instructions that provide for determining whether to grant the non-sealing entity access to the sealed data further comprise:
instructions that provide for denying the non-sealing entity access to the sealed data.

16. The article of claim 10, wherein instructions that provide for determining whether to grant the non-sealing entity access to the sealed data further comprise:
instructions that provide for granting the non-sealing entity access to the sealed data.

17. A system comprising:
a security module; and
a proxy, the proxy including:
a data sealing module to request that the security module provide for sealing data, the data being provided by a sealing entity; and
an access request arbitration module to arbitrate an access request from a non-sealing entity, wherein the access request requests that the non-sealing entity gain access to the sealed data.

18. The system of claim 17, wherein the access request arbitration module further includes:
an access control list processing module to determine whether an access control list indicates that the non-sealing entity should gain access to the sealed data; and
a user response processing module to obtain and evaluate a user selection, the user selection indicating whether the non-sealing entity should gain access to the sealed data.

19. The system of claim 17, wherein the access request arbitration module further includes:
an access notification module to notify the non-sealing entity whether the request has been granted.

20. The system of claim 17, wherein the data sealing module requests that the security module provide for sealing data at least by:
receiving the data from the sealing entity;
providing the data to the security module;
receiving a first data seal request from the sealing entity; and
providing a second data seal request to the security module.

21. The system of claim 17, wherein the access request arbitration module arbitrates a request from a non-sealing entity at least by:
receiving an access request from the non-sealing entity; and
determining whether an access control list includes an identifier for the non-sealing entity.

22. The system of claim 17, wherein the access request arbitration module arbitrates a request from a non-sealing entity at least by:
receiving an access request from the non-sealing entity; and
performing trusted input/output with a user to obtain a user selection.

23. The system of claim 17, wherein the access request arbitration module arbitrates a request from a non-sealing entity at least by:
receiving access control information from the sealing entity; and
updating an access control list to reflect the access control data.

24. The system of claim 17, wherein the access request arbitration module arbitrates a request from a non-sealing entity at least by:
receiving access control information from a user; and
updating an access control list to reflect the access control data.
